(19) United States
(12) Patent Application Publication
(10) Pub. No.: US 2009/0148954 A1
(43) Pub. Date: Jun. 11, 2009

(54) APPARATUS FOR IDENTIFYING EXPLOSIVE MATERIALS

(76) Inventors: Uzi Malimovka, Givat Shmuel (IL); Gadi Aner, Caesarea (IL)

Correspondence Address: YORAM TSIVION, P.O. BOX 1307, PARDES HANNA, 37111, IL

(21) Appl. No.: 11/926,194

(22) Filed: Oct. 29, 2007

(51) Int. Cl. G01N 21/00; B01J 19/00

(52) U.S. Cl. 436/164; 422/68.1; 422/83; 422/86; 422/82.05

(57) ABSTRACT

An apparatus for identifying suspected materials, includes: an upper portion and a lower portion; one or more cylinders for containing reactive material; one or more activation handles for releasing the contents of the cylinders, wherein one or more activation handle is slidable along a respective slot in an upper cover portion of the apparatus; one or more piston associated respectively with the cylinders, and with the activation handles, respectively; one or more fixed needle affixed to a frame, wherein a respective tip of the needles is pointed towards a respective bottom stopper of a cylinder, and; reaction chamber affixed below the frame, capable of receiving a flowable agent from the needles.

### FIELD OF THE INVENTION

The present invention relates to methods and apparatus for identifying explosive or hazardous materials. More specifically the invention relates to a tool to aid in identification of hazardous materials by eliciting a chemical reaction forming visibly detectable products.

### BACKGROUND OF THE INVENTION

In recent years, the threat from hostile attacks involving explosive charges in pubic places has become a prominent concern in western countries as well as in other societies. Law enforcement agents are busy inspecting packages, parcels, containers and other objects for the presence of explosives, bio-hazardous and other hazardous materials. Such inspections are typically conducted in airports, mall entrances, seaports, train stations, depots and bus stations. Such inspections carried out by the agents are time consuming, sometimes reducing the mobility of the citizens substantially. To increase the effectiveness of the inspections, a variety of auxiliary means are utilized. Means known in the art include use of X-ray machines, metal detectors, and sniffers (dogs or artificial).

Peroxide-based explosives, such as triacetone triperoxide (TATP) and others are difficult to identify, as they lack functional groups containing oxygenated nitrogen, are colourless, and generally inconspicuous. Such explosives can be easily prepared, and therefore be used in improvised explosive devices (IEDs). The base materials for the preparation of such explosives are easily obtained and they are therefore fast becoming the explosives of choice for terrorists worldwide.

### SUMMARY OF THE INVENTION

The present invention provides an apparatus for analysing sampled material. The apparatus of the invention typically possesses several separate containers. In preferred embodiments, these containers contain different fluids respectively. The role of the fluids is to react with a sample of suspicious material, to thus facilitate identification of certain traits. The reaction in a preferred embodiment of the invention is colour forming, hence, visibly indicating the existence of one or more specific molecular structures associated with explosives or other hazardous materials.

A notable implementation of the apparatus of the invention is in the detection of hazardous materials related to terrorist activity. In one preferred embodiment of the invention, the containers bearing the fluids mentioned above are cylindrical, constructed of glass and/or plastic materials, sealed by plugs made of rubber or plastic materials. In operation, these cylinders are pushed in a predetermined sequence to exclude the fluids therefrom and subsequently perform a calorimetric reaction. The exclusion of the fluids from each cylinder occurs after a needle penetrates a rubber plug thereby allowing the fluid inside to flow into a reaction chamber. There they mix and a reaction with a sample of a material occur wherein the materials contained within the sample react with the fluids, and ultimately produce a change in colour inside a transparent reaction chamber.

### BRIEF DESCRIPTION OF THE DRAWINGS

FIG. 1 is an isometric view of an apparatus of the invention;

FIG. 2A is an exploded view of the apparatus of FIG. 1 showing main parts;

FIG. 2B is an exploded view of the apparatus of FIG. 1 showing interior parts in pre and post actuation positions;

FIG. 3 is an internal view of the lower portion of the apparatus of FIG. 1;

### DETAILED DESCRIPTION OF THE PRESENT INVENTION

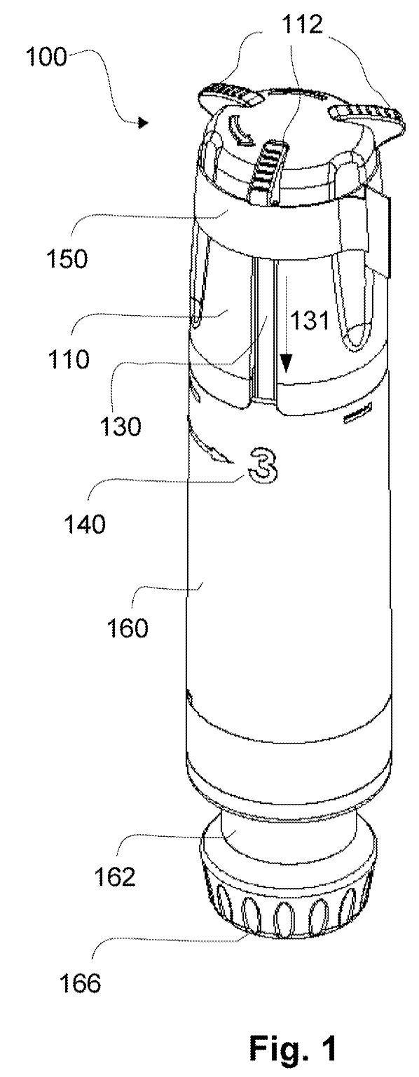

Referring to FIG. 1, a preferred embodiment of an analysing device made in accordance with the present invention is shown. Analysing device 100 includes, upper cover portion 110 and protruding activation handles 112. Each handle is slidable along a respective slot, such as 130. The sliding movement is directed downwards, in a direction shown by arrow 131. Numeric labels such as label 140 are disposed beneath each respective slot to designate the correct order of depressing the activation handles. Safety catch ribbon 150 snugly fits around activation handles 112. Further below, lower cover portion 160 is attached to transparent chamber 162. Chamber 162 is a multi functional container which functions both as a reaction chamber, i.e. a container in which the calorimetric reaction takes place, and as a holder of detachable sampling cap 166. The lower portion of the device can optionally be tinted by a specific colour to improve user's visual observation of the reaction inside the chamber.

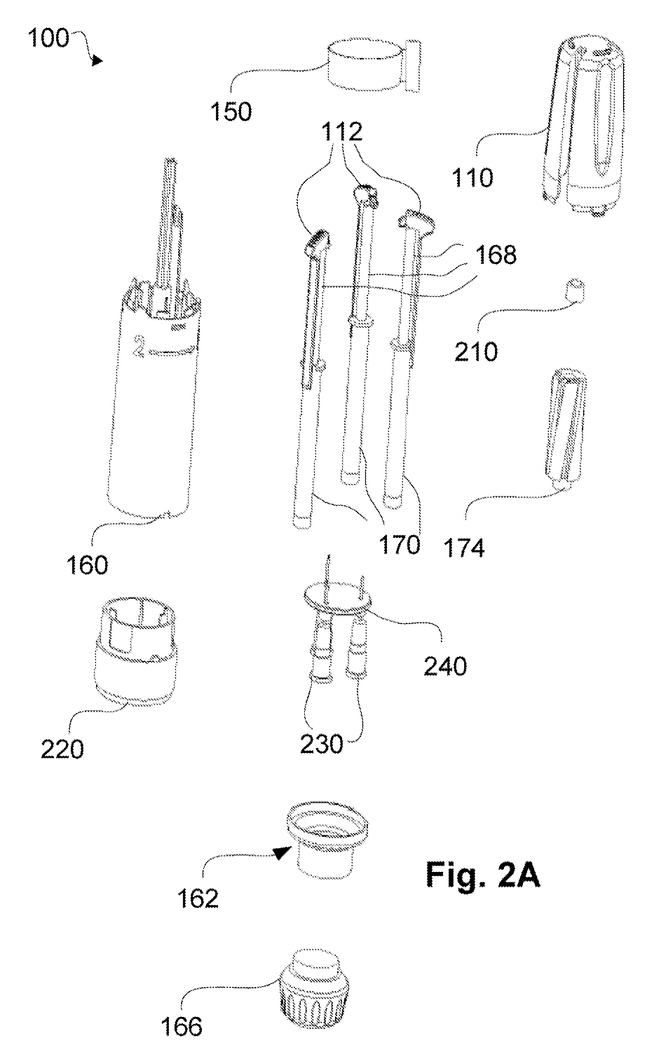

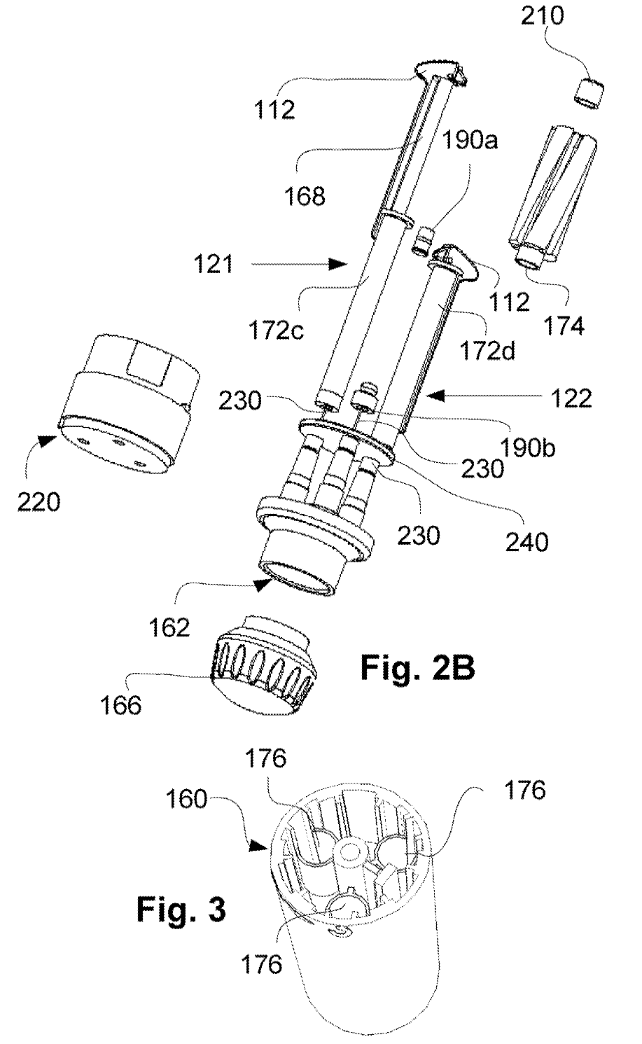

In FIG. 2A, to which reference is now made, an exploded view of a preferred embodiment of the invention is shown. Upper cover portion 110 includes slots in which activation handles 112 are incorporated (not shown). Each activation handle is associated with respective piston 168 and respective cylinder 170. The cylinders are typically made of but not restricted to glass and/or plastic materials. Sequencer 174 is a cylindrical body in which, typically, helical grooves are disposed along the exterior surface thereof. This provides for each handle to be depressed in the correct order. Due to the helical course of the grooves, each time the activation handle is depressed, the longitudinal translation thereof correspondingly causes a rotation of the sequencer around its longitudinal axis. As a result, the groove is rotated towards the next activation handle, so as to be receptive of this next handle. Spacer 210 restricts the vertical movement of the sequencer. The combined functionality of the sequencer and spacer as well as safety catch ribbon 150 is to protect against accidental actuation of the apparatus. Cylinders 170 each contain a different fluid. As can be seen in FIG. 2B to which reference is now made, the cylinders are sealed, at both ends, by top and bottom plug, 190a and 190b respectively. These plugs are typically made of but not restricted to rubber or plastic materials. As can be seen in FIG. 3, to which reference is made now, cylinders 172c and 172d of FIG. 2B are inserted into cylindrical receptacles 176 of lower cover portion 160; Referring again to FIG. 2A, needles frame 220 holds and encircles the lower portion of fixed needles 230, adjacent the lower end of the cylinders. Referring again to FIG. 2B, the tips of the fixed needles penetrate through an orifice of stopper 240. Chamber 162 is connected to the lower part of frame 220 while detachable cap 166 shuts off chamber 162 from below. The figure describes the device of the invention with the upper and lower cover portion removed. The pre-operating and post-operating positions of the piston assembly are described. The pre-operating position is demonstrated by piston assembly 121 while the post-operating position is demonstrated by piston assembly 122. The transfer of flowable material (liquid, gas or vapour) from within cylinders 172c and 172d takes place when the user depresses or displaces activation handles 112. Piston assembly 122 is shown in a post-operating position, in which activation handle 112 is fully depressed, in respective cylinder 172c, toward needles 230 fixed to frame 220. This transfer continues until activation handles 112 abut stopper 240, which functions both as a guide and as a spacer by limiting the progress of pistons 168 and the cylinders. On their forced descent, plugs 190b are punctured by respective fixed needles 230. Subsequently, the needles penetrate into the lumen of the respective cylinders containing each a flowable that up to this stage were secured and sealed within the cylinders. The contents of the respective lumens flow downwards, through respective needles, each such needle located in a respective orifice of frame 220, towards chamber 162. From the respective needles, the contents flow into chamber 162. Detachable cap 166 functions both as a bottom sealer of the chamber and as a swab, for collecting a sample. The swabbing surface is constructed of sticky rubber or other adhesive materials, but may also be covered by a rough surface to maximize the efficiency of collecting either solids or liquids.

The analytical process may take place in two main steps, the first is the collecting of the sample and the second the chemical testing of the sample. The collection can be executed by first removing the detachable cap from the reaction chamber described supra. Following, the sample is collected, typically by forming a contact between the suspected material and the cap. The cap can then be reattached to the reaction chamber. The samples to be collected may be of any physical form, such as gasses, liquids, emulsions, aerosols, vapours, solid substances, and any of their homogeneous or heterogeneous mixtures. The testing step then follows: firstly, the apparatus is held in a vertical orientation and the safety ribbon removed; secondly, the activation handles of pistons are pushed downwards in the order of their numerical labels. As a result, the plugs are punctured by respective fixed needles, and the contents of cylinders are injected into the reaction chamber, thereby allowing a colourimetric reaction to take place. The colours produced are observable through the transparent wall of the reaction chamber.

### Benefits of the Invention

The design disclosed isolates the contents of the cylinders, so that there is no reaction with the outside environment (e.g., oxidation) for a long period of time, which promotes longer time before expiration of the product. Moreover, the isolation enables a safe transportation of the device and its chemical traces, to chemical waste facilities. Secondly, the design permits precise and relatively small amounts of flowables to be retained unmixed in separate chambers and permits the fluid to be discharged with very small dead volume remaining. In addition, the embodiments disclosed herein are compact, safe and require little mechanical effort in use.

1. An apparatus for identifying suspected materials selected from the group consisting of: gases, liquids, emulsions, aerosols, solid substances, comprising:
an upper portion and a lower portion;
at least one cylinder for containing reactive material;
at least one activation handle for releasing the contents of said at least one cylinder, wherein said at least one activation handle is slidable along a respective slot in an upper cover portion of said apparatus;
at least one piston associated respectively with said at least one cylinder, and with said at least one activation handle, respectively;
at least one fixed needle affixed to a frame, wherein a respective tip of said at least one needle is pointed towards a respective bottom stopper of a cylinder, and;
a reaction chamber affixed below said frame, capable of receiving a flowable agent from said at least one needle.

2. The apparatus of claim 1, wherein the lower portion further comprises a detachable cap.

3. The apparatus of claim 1, wherein said cylinder includes at least one sealing plug.

4. The apparatus of claim 1, wherein one or more portions of the apparatus are transparent.

5. The apparatus of claim 1, wherein said chamber is transparent.

6. The apparatus of claim 1, providing one or more orifices in said stopper.

7. The apparatus of claim 1, wherein said lower portion is brightened by lustrous colours.

8. A method for identifying dangerous material, comprising the steps of:
collecting a sample by swabbing with a cap
attaching said cap to a reaction chamber;
pushing activation handles for injecting at least one reactant from cylinders to said reaction chamber, in a predefined order;
causing a reaction, and;
observing colour changes in said reaction chamber.
